(19) United States
(12) Patent Application Publication
(10) Pub. No.: US 2014/0213079 A1
(43) Pub. Date: Jul. 31, 2014

(54) CONNECTOR

(71) Applicants: JAPAN AVIATION ELECTRONICS INDUSTRY, LIMITED, Tokyo (JP); JAE ELECTRONICS, INC., Irvine, CA (US)

(72) Inventors: Takayuki NISHIMURA, Tokyo (JP); Joe MOTOJIMA, Irvine, CA (US)

(73) Assignees: JAE ELECTRONICS, INC., Irvine, CA (US); JAPAN AVIATION ELECTRONICS INDUSTRY, LIMITED, Tokyo (JP)

(21) Appl. No.: 13/752,645

(22) Filed: Jan. 29, 2013

(51) Int. Cl. H01R 12/70

(52) U.S. Cl. CPC H01R 12/7082
USPC 439/78

(57) ABSTRACT

A connector comprises a contact and a housing. The contact has a fixed portion, a contact portion, a spring portion and a held portion. The spring portion supports the contact portion. The held portion is located between the fixed portion and the support portion. The housing has a sidewall portion and a bottom portion. The sidewall portion is located outward of the spring portion in a predetermined direction and holds the held portion. The bottom portion is located under the spring portion in a vertical direction perpendicular to the predetermined direction. The housing has a gap between a lower surface of the spring portion and the bottom portion. The bottom portion and the sidewall portion hide the contact except the held portion both when the connector is seen from below along the vertical direction and when the connector is seen from the outside along the predetermined direction.

### BACKGROUND OF THE INVENTION

This invention relates to a connector configured to be mounted on a circuit board.

As shown in FIG. 1, a connector disclosed in JP-A 2004-55463 comprises a housing made of an insulating material and contacts held by the housing. The contacts are press-fit in the housing from above.

As shown in FIG. 2, a connector disclosed in WO 2008/139554 comprises a housing made of an insulating material and contacts held by the housing. The housing is formed from two members. Each of the contacts is partially embedded in one of the members of the housing via insert-molding.

As for the connector of JP-A 2004-55463, the housing is required to have an outer surface formed with a region where a fixed portion of the contact passes through when the contact is press-fit into the housing. Accordingly, the contact is visible when the outer surface of the housing is seen from the outside. Thus, the contact may be exposed to moisture or gases through the outer surface of the housing. The contact therefore may be rusted.

The housing of WO 2008/139554 has a hole which opens at a bottom portion thereof. The hole is located right under the contact. Accordingly, the contact may be exposed to moisture or gases through the bottom portion of the housing. The contact therefore may be rusted. Moreover, the contact may be contaminated by scattered flux or solder when the connector is attached to a circuit board.

### SUMMARY OF THE INVENTION

It is therefore an object of the present invention to provide a connector having a contact configured to be less exposed, particularly in a mated state, and less contaminated.

One aspect (first aspect) of the present invention provides a connector configured to be mounted on a circuit board. The connector comprises a contact and a housing. The contact has a fixed portion, a contact portion, a spring portion and a held portion. The fixed portion is configured to be fixed to the circuit board. The spring portion supports the contact portion. The held portion is located between the fixed portion and the support portion. The housing has a sidewall portion and a bottom portion. The sidewall portion is located outward of the spring portion in a predetermined direction and holds the held portion. The bottom portion is located under the spring portion in a vertical direction perpendicular to the predetermined direction. The housing has a gap between a lower surface of the spring portion and the bottom portion. The bottom portion and the sidewall portion hide the contact except the held portion both when the connector is seen from below along the vertical direction and when the connector is seen from outside along the predetermined direction.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a cross-sectional view showing an existing connector.

FIG. 2 is a cross-sectional view showing another existing connector.

FIG. 3 is a partially cutaway, perspective view showing a connector according to an embodiment of the present invention.

FIG. 4 is a cross-sectional view showing the connector of FIG. 3.

FIG. 5 is a partial, side view showing the connector of FIG. 3.

FIG. 6 is a partial, bottom view showing the connector of FIG. 3.

FIG. 7 is a partially cutaway, perspective view for explanation of a manufacturing process of the connector of FIG. 3.

FIG. 8 is another partially cutaway, perspective view for explanation of the manufacturing process of the connector of FIG. 3.

FIG. 9 is a cross-sectional view, similar to FIG. 4, showing the spring portion resiliently maximally deformed.

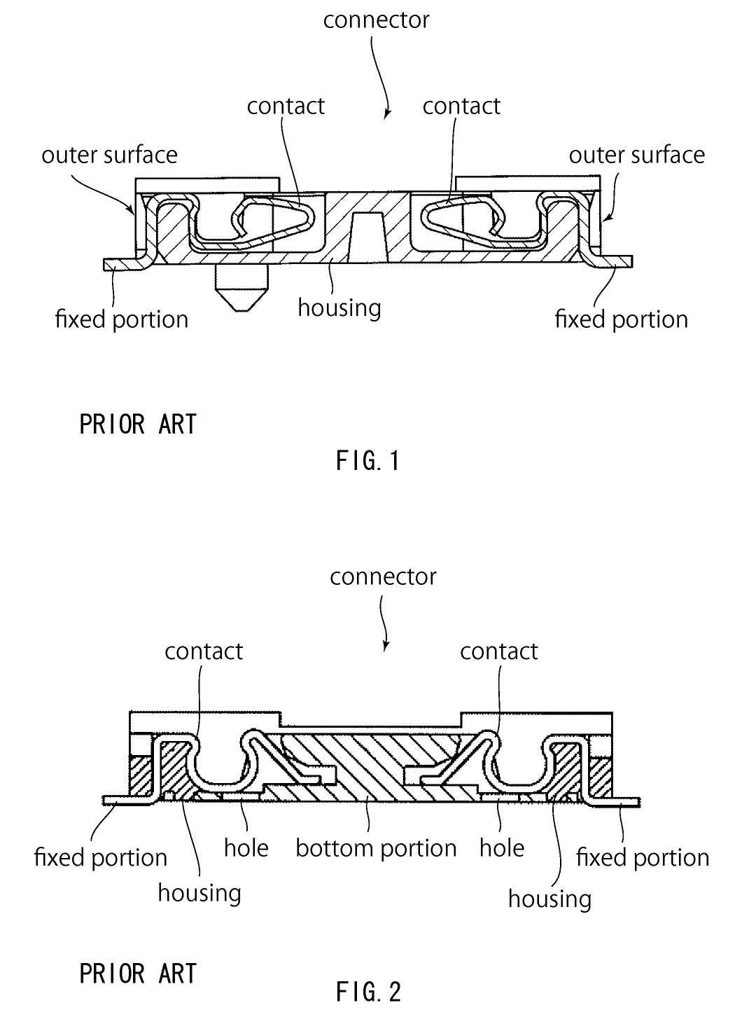

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

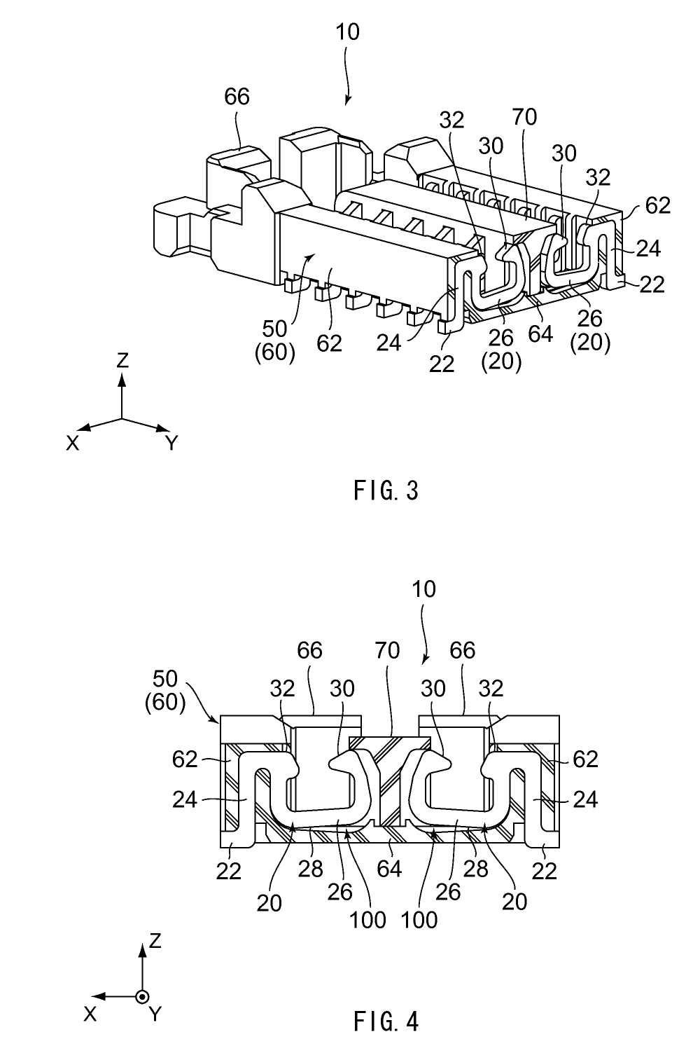

Referring to FIGS. 3 to 6, a connector 10 according to an embodiment of the present invention is configured to be mounted on a circuit board (not shown) for use.

The connector 10 comprises a plurality of contacts 20 each made of a conductive material and a housing 50 made of an insulating material. The connector 10 may further comprise a metallic member such as a reinforcement member, a shell or a hold-down.

As can be seen from FIGS. 3, 5 and 6, the contacts 20 are classified into two groups. The contacts 20 of each of the groups are arranged in the Y-direction (pitch direction). The contacts 20 of one of the two groups are arranged back-to-back with the contacts 20 of another one of the two groups in the X-direction (predetermined direction), respectively. As shown in FIG. 4, the contacts 20 of one of the two groups and the contacts 20 of another one of the two groups are arranged symmetrically relative to the middle of the housing 50 in the X-direction.

As shown in FIG. 4, each of the contacts 20 has a fixed portion 22 configured to be fixed to the circuit board (not shown), a held portion 24 held by the housing 50, a spring portion 26 which is resiliently deformable, and a contact portion 30 supported by the spring portion 26. The contact portion 30 is connected to a contact of a mating connector (not shown) under a mated state where the connector 10 is mated with the mating connector (not shown). The contact portion 30 according to the present embodiment is supported by an end of the spring portion 26. The contact portion 30 protrudes outward in the X-direction. Thus configured contact portion 30 is movable because of the resilience of the spring portion 26. The spring portion 26 is provided with a protruding portion 32. The protruding portion 32 according to the present embodiment protrudes inward in the X-direction. The protruding portion 32 faces the contact portion 30 in the X-direction.

More specifically, the fixed portion 22 of the contact 20 according to the present embodiment has a short linear shape extending along the X-direction. The held portion 24 has an L-like shape. The held portion 24 extends toward the positive Z-side of the contact 20 (i.e. extends upward) in the Z-direction (vertical direction) from an inner end of the fixed portion 22 in the X-direction. The spring portion 26 has a U-like shape or a C-like shape opening toward the positive Z-side thereof (i.e. opening upward). Accordingly, the spring portion 26 has two ends. The spring portion 26 extends toward the negative Z-side of the contact 20 (i.e. extends downward) in the Z-direction from an inner end of the held portion 24 in the X-direction. The protruding portion 32 is provided at the one end, which is nearer to the held portion 24, of the spring portion 26. The contact portion 30 is provided at the other end (i.e. free end) of the spring portion 26.

As shown in FIGS. 3 and 4, the housing 50 according to the present embodiment is comprised of a first member 60 and a second member 70. The first member 60 has two sidewall portions 62, a bottom portion 64 and two end portions 66. Each of the sidewall portions 62 extends long in the Y-direction. The bottom portion 64 couples a negative Z-side end (i.e. lower end) of one of the sidewall portions 62 and a negative Z-side end of another one of the sidewall portions 62 with each other in the X-direction. Each of the end portions 66 couples an end of one of the sidewall portions 62 and an end of another one of the sidewall portions 62 with each other. The two sidewall portions 62 and the two end portions 66 form a frame body. The second member 70 has a block-like shape extending long in the Y-direction. The second member 70 is able to partially accommodate each of the contacts 20. According to the present embodiment, the second member 70 is put in the first member 60 after the first member 60 is formed.

As shown in FIGS. 3 and 4, each of the contacts 20 according to the present embodiment is partially embedded in the first member 60 of the housing 50 via insert-molding. In detail, the held portion 24 is held by the sidewall portion 62 via insert-molding. The held portion 24 is thus held so that the spring portion 26 is located inward of the sidewall portion 62 in the X-direction. In other words, the sidewall portion 62 is located outward of the spring portion 26 in the X-direction. The spring portion 26 is located over the positive Z-side (i.e. upper side) of the bottom portion 64 in the Z-direction. In other words, the bottom portion 64 is located under the negative Z-side (i.e. lower side) of the spring portion 26 in the Z-direction. The fixed portion 22 according to the present embodiment protrudes outward in the X-direction from the sidewall portion 62. The protruding portion 32 is not covered by the sidewall portion 62 and is visible when seen from the positive Z-side thereof (i.e. from above). Accordingly, the protruding portion 32 is able to be pressed from the positive Z-side thereof (i.e. from above) in the Z-direction.

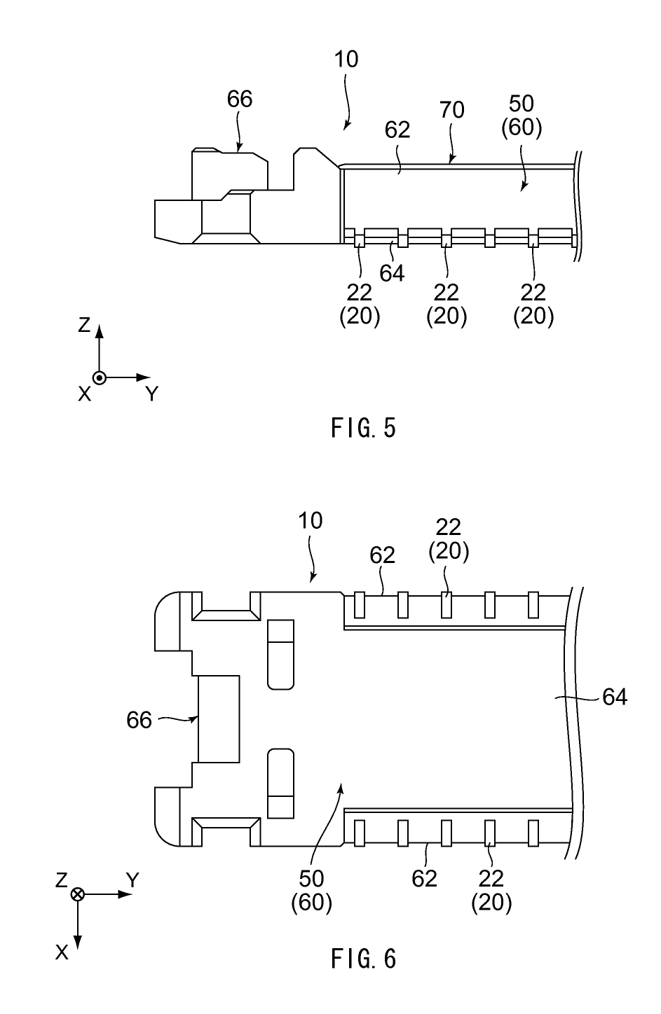

As shown in FIG. 5, when the connector 10 according to the present embodiment is seen from the outside in the X-direction, the sidewall portion 62 of the first member 60 of the housing 50 hides the contact 20 for the most part so that only the fixed portion 22 of the contact 20 is visible. In other words, the sidewall portion 62 hides the contact 20 except the fixed portion 22 when the connector 10 is seen from the outside along the X-direction.

As shown in FIG. 6, the bottom portion 64 is formed from a part of a single member, namely, the first member 60. The bottom portion 64 is provided with no holes corresponding to the contacts 20, respectively. Accordingly, when the connector 10 according to the present embodiment is seen from the negative Z-side thereof (i.e. from below) in the Z-direction, the bottom portion 64 of the first member 60 of the housing 50 hides the contact 20 for the most part so that only the fixed portion 22 of the contact 20 is visible. In other words, the bottom portion 64 hides the contact 20 except the fixed portion 22 when the connector 10 is seen from the negative Z-side thereof (i.e. from below) along the Z-direction.

As described above, according to the present embodiment, only the fixed portion 22 of the contact 20 is visible when the connector 10 is seen from the negative Z-side thereof (i.e. from below) in the Z-direction or from the outside in the X-direction. Accordingly, only the fixed portion 22 of the contact 20 is exposed out of the housing 50, particularly under the mated state. According to the present embodiment, there is little possibility that the contact 20 is contaminated.

As best shown in FIG. 4, under an unmated state of the connector 10 according to the present embodiment, the housing 50 has a gap 100 between a lower surface 28 of the spring portion 26 and the bottom portion 64 of the first member 60 thereof. Accordingly, the spring portion 26 is resiliently deformable or shows resilience within the gap 100. Moreover, the gap 100 for resilient deformation of the spring portion 26 is provided at the negative Z-side of the spring portion 26 (i.e. under the spring portion 26) so that the contact 20 is not required to have a large size in the X-direction. According to the present embodiment, the connector 10 may have a reduced size in the X-direction.

If the contact 20 is ordinarily held by the housing 50 via insert-molding, it is difficult to provide the gap 100 between the spring portion 26 and the bottom portion 64 while hiding the most part of the contact 20 by the bottom portion 64. According to an existing insert-molding, it is necessary to form a hole or an opening piercing the bottom portion 64 of the housing 50 in order to provide a space for resilient deformation of the spring portion 26 under the spring portion 26 of the contact 20. In other words, if the contact 20 is embedded into the housing 50 via the existing insert-molding, the spring portion 26 of the contact 20 is buried in the bottom portion 64 unless the bottom portion 64 is formed with a hole. The spring portion 26 is therefore unable to show the resilience.

Unlike the existing insert-molding, during the first member 60 is formed via insert-molding according to the present embodiment, the spring portion 26 is applied with a stress which maintains the spring portion 26 in a resiliently deformed state so that the gap 100 according to the present embodiment is formed.

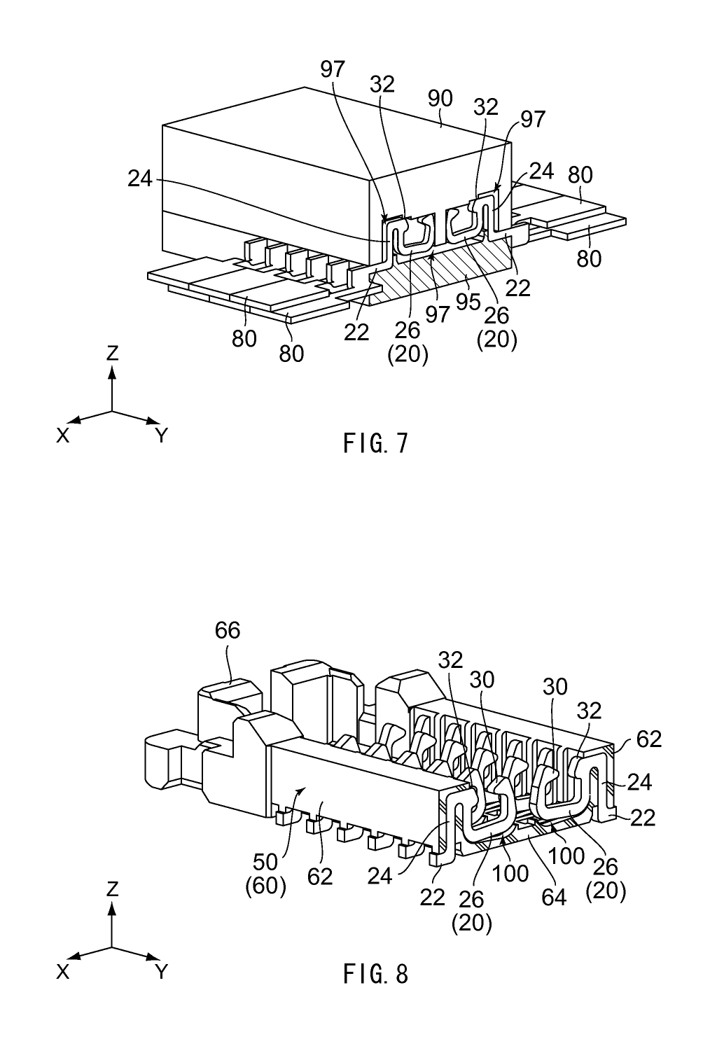

In detail, as shown in FIG. 7, the contacts 20 with carriers 80 are held by an upper die 90 and a lower die 95. Then, a resin is poured into a cavity 97 formed by the upper die 90 and the lower die 95 so that the first member 60 of the housing 50 according to the present embodiment is formed. During the forming of the first member 60, the fixed portion 22 of each of the contacts 20 is caught between the upper die 90 and the lower die 95, and the protruding portion 32 is brought into contact with the upper die 90. In other words, the upper die 90 and the lower die 95 support three parts of the contact 20, namely, the positive Z-side surface (i.e. upper surface) of the fixed portion 22, the negative Z-side surface (i.e. lower surface) of the fixed portion 22 and the protruding portion 32. The contact 20 is thus supported so that it is possible to prevent the contact 20 from rotating in the XZ-plane.

According to the present embodiment, when the contact 20 is in the aforementioned supported state, the upper die 90 is pressed against and applies a load to the free end of the spring portion 26 or the contact portion 30. The load moves the contact portion 30 along the negative Z-direction (i.e. moves downward) from the initial position under the unmated state (see FIGS. 3 and 8). In other words, the spring portion 26 of the contact 20 is resiliently deformed during insert-molding. As shown in FIG. 8, when the upper die 90 and the lower die 95 are detached after insert-molding, the resilience of the spring portion 26 returns the spring portion 26 to the initial position under the unmated state. Accordingly, the gap 100 is formed between the lower surface 28 of the spring portion 26 and the bottom portion 64 of the first member 60 of the housing 50.

Thereafter, as shown in FIG. 8, the carriers 80 are cut off from the contacts 20. Then, the second member 70 is put in the first member 60 so that the connector 10 shown in FIG. 3 is obtained.

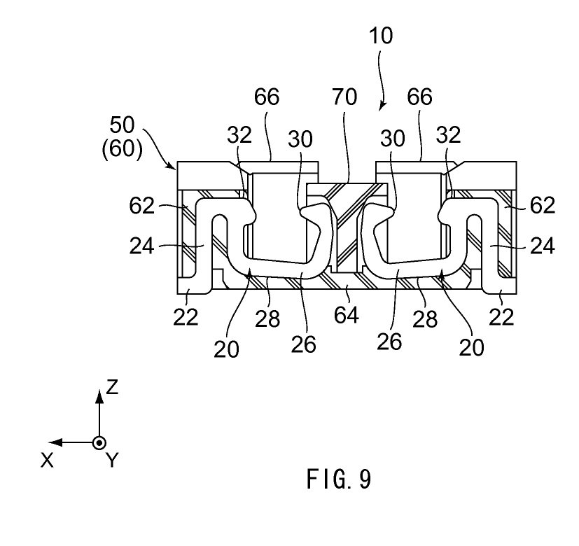

As best shown in FIG. 4, the gap 100 according to the present embodiment is formed as described above so that the bottom portion 64 has a shape formed by partially printing the shape of the spring portion 26. More specifically, as shown in FIG. 9, the bottom portion 64 has the shape that allows the lower surface 28 of the spring portion 26 and the bottom portion 64 to be brought into contact with each other without any gaps if the spring portion 26 is resiliently maximally deformed toward the negative Z-side of the contact 20 (i.e. deformed downward), that is to say, if the spring portion 26 is further resiliently deformed from the shape under the mated state of the connector 10 with the mating connector (not shown). As described above, according to the present embodiment, the gap 100 for the resilient deformation of the spring portion 26 is formed between the spring portion 26 and the bottom portion 64 even if the contact 20 is held by the first member 60 of the housing 50 via insert-molding.

According to the aforementioned embodiment, the fixed portion 22 protrudes outward in the X-direction from the sidewall portion 62 of the housing 50. However, the fixed portion 22 may be formed differently. For example, the fixed portion 22 may not protrude outward in the X-direction from the sidewall portion 62 of the housing 50 if not the fixed portion 22 but a part of the carrier 80 is put between the upper die 90 and the lower die 95 during insert-molding.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector configured to be mounted on a circuit board, the connector comprising:
a contact having a fixed portion, a contact portion, a spring portion and a held portion, the fixed portion being configured to be fixed to the circuit board, the spring portion supporting the contact portion, the held portion being located between the fixed portion and the support portion; and
a housing having a sidewall portion and a bottom portion, the sidewall portion being located outward of the spring portion in a predetermined direction and holding the held portion, the bottom portion being located under the spring portion in a vertical direction perpendicular to the predetermined direction, the housing having a gap between a lower surface of the spring portion and the bottom portion, the bottom portion and the sidewall portion hiding the contact except the held portion both when the connector is seen from below along the vertical direction and when the connector is seen from outside along the predetermined direction.

2. The connector as recited in claim 1, wherein the held portion is held by the sidewall portion via insert-molding.

3. The connector as recited in claim 1, wherein the bottom portion has a shape that allows the lower surface of the spring portion and the bottom portion to be brought into contact with each other without any gaps if the spring portion is resiliently maximally deformed downward.

4. The connector as recited in claim 1, wherein:
the fixed portion protrudes outward from the sidewall portion in the predetermined direction; and
the spring portion has a protruding portion which is arranged to be able to be pressed from above in the vertical direction.

5. The connector as recited in claim 1, wherein:
the fixed portion extends in the predetermined direction;
the held portion has an L-like shape and extends upward in the vertical direction from an inner end of the fixed portion in the predetermined direction; and
the spring portion has a U-like shape and extends downward in the vertical direction from an inner end of the held portion in the predetermined direction.
